(19) United States
(12) Patent Application Publication
(10) Pub. No.: US 2013/0342344 A1
(43) Pub. Date: Dec. 26, 2013

(54) Wireless Mousetrap and System

(71) Applicant: BlueRadios, Inc., Englewood, CO (US)

(72) Inventors: Mark Kramer, Castle Rock, CO (US); Wilfred Tucker, Centennial, CO (US); John Sample, Centennial, CO (US); Christopher Bermel, Denver, CO (US)

(21) Appl. No.: 13/922,453

(22) Filed: Jun. 20, 2013

Related U.S. Application Data
(60) Provisional application No. 61/661,838, filed on Jun. 20, 2012.

(51) Int. Cl. A01M 23/00

(52) U.S. Cl. CPC A01M 23/00
USPC 340/539.1; 43/58; 43/60

(57) ABSTRACT

A wireless trap and system of monitoring said trap is described and taught. The wireless trap is preferably a spring loaded trap with a wireless transmitter coupled to the trap. Upon activation of the trap by a pest or rodent, the wireless transmitter sends a signal or alert to a Bluetooth® enabled receiver. The signal or alert sent to the Bluetooth® receiver is sent by the wireless transmitter once a certain gravitational force (g-force) threshold is reached through the trap. This threshold is determined by an accelerometer present in the trap. Once the user receives a signal or alert on any Bluetooth® enabled device, they can check the trap and dispose of the pest or rodent.

### CLAIM OF PRIORITY

This application claims the priority of U.S. Ser. No. 61/661,838 filed on Jun. 20, 2012, the contents of which are fully incorporated herein by reference.

### FIELD OF THE INVENTION

The field of the invention relates to pest (mouse) control and techniques for wireless sensing and alerting of the status of a pest control apparatus to an individual with a receiving device.

### BACKGROUND OF THE INVENTION

The controlling of pests by a variety of means has long been a challenge for man. This challenge has given rise to a number of different types of methods of pest control. There are traps that kill, traps that allow the victim to live, poisons, and so forth. These means all require manual checking of the traps. Depending on the circumstances, this laborious checking of traps can cost an individual or company time and money. Additionally, traps left unchecked for some amount of time after capture can pose additional health problems stemming from decaying matter or pathogens/parasites carried by the animal victim.

There is a need for a trap that reliably alerts a particular individual(s) to the presence of a particular pest located within the particular trapping apparatus that is functional across a wide variety of apparatus. Among the various means of alerting to such a presence, the most efficient is by using wireless communication devices. This has resulted in a number of different types of wireless pest control traps. There are traps that use infrared beams and networks to monitor such apparatus. However, these fall short of fully solving the issue at hand.

The previous attempts to solve this problem do so with radio frequency means. The problem with using this technology is that it does not employ frequency-hopping spread spectrum transceivers or guaranteed packet delivery. Thus, it is susceptible to various interferences that may, among other outcomes, result in false positive readings or no reading at all. Additionally, existing wireless pest control apparatus communicate with dedicated receivers and networks. The end result is a requirement for a particular, specialized receiver that limits the technology to a particular range or apparatus. Thus, the receiving apparatus must be in a fixed location or one may risk being out of range and unable to receive a signal from the pest control apparatus. Previous attempts have also employed battery-free apparatus. The battery-free apparatus is at a distinct disadvantage because only a small amount of energy can be stored and transmitted at any given time. Thus, multiple packet delivery attempts are not in practice with these apparatus, and there is not enough energy to harvest in limited movement (i.e. glue traps).

No prior art has fully addressed the issues at hand in the manner herein described. In view of the aforementioned limitations, there is a need for an improvement to the existing technology to combat these issues.

### SUMMARY OF THE INVENTION

According to a first aspect of the invention, a wireless pest control apparatus comprises a mousetrap with a wireless transmitter coupled to the mousetrap. The mousetrap has at least one movable part and the wireless transceiver, or transmitter, contains a digital accelerometer, coin type battery, and may have a status light emitting diode (LED). The transceiver as a whole is encased in epoxy. Upon, activation of the mousetrap, by way of a gravitational force sensed by a digital accelerometer, a wireless signal is sent from the wireless transmitter to a Bluetooth® low energy compatible device (receiver). The receiver may be a number of devices including laptops, PCs, and smartphones. The apparatus is preferably powered by a Lithium coin cell battery, but may be powered by another similar power source.

In an alternate embodiment, the trap has no movable parts and may be a glue trap or the like. Thus, the movement of the trap itself will be sufficient to generate a signal send to the paired receiver by manipulating the gravitational force settings of the digital accelerometer.

According to another aspect of the invention, there is a system for monitoring a wireless trap comprising a wireless trap and a receiver that operates over Bluetooth® low energy channels. The activation of the trap by an animal permits the wireless transmitter to send at least one signal to a receiver. The signal, or alert, can be audio, vibrational, or visual in nature. In order to pair the devices, a user can employ a number of methods. These include push button pairing and taking advantage of near field communication technology.

These and other embodiments will be better understood in conjunction with the drawings and descriptions that follow.

It is an object of the present invention to provide a wireless trap for catching mice, rats, and the like.

It is an object of the present invention to provide an easy and effective way to monitor the wireless trap.

It is an object of the present invention to provide a wireless trap that can be cleaned easily and effectively.

It is another object of the present invention to provide a reliable alert system upon trap activation.

It is another object of the present invention to create a wireless alert that is compatible with non-dedicated transmitters and receivers.

It is another object of the present invention to monitor a trap using gravitational forces (g-forces).

### BRIEF DESCRIPTION OF THE DRAWINGS

Embodiments of the present invention will now be described, by way of example only, with reference to accompanying drawings, in which:

FIG. 1 illustrates a preferred embodiment of the present invention.

FIG. 2 illustrates a component view of a wireless transmitter.

FIG. 3 is a block diagram demonstrating the functionality of the system as intended.

### DETAILED DESCRIPTION

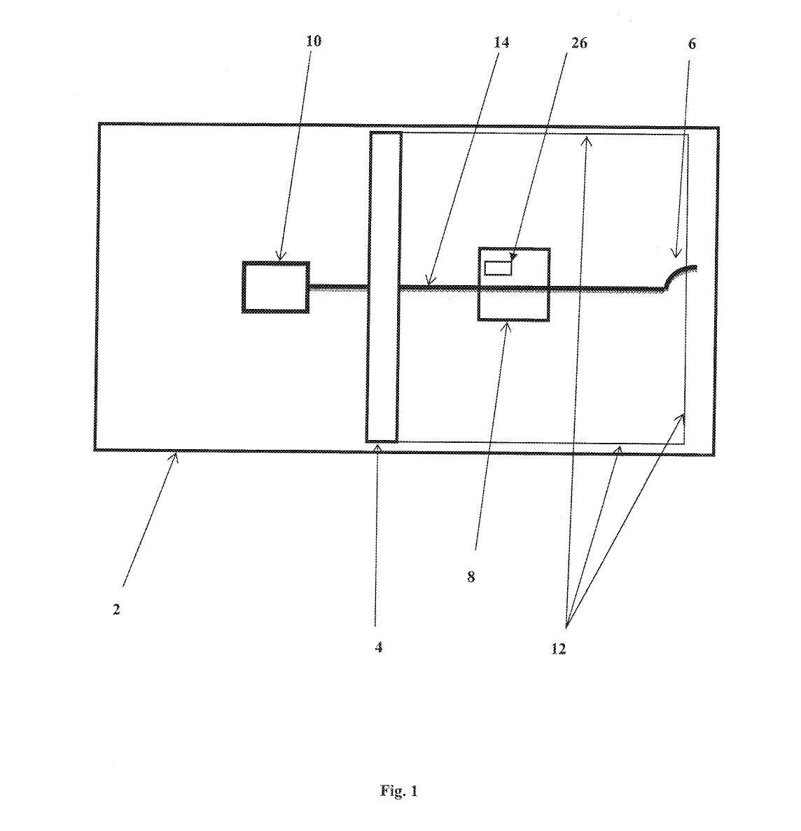

Referring to the drawings, FIG. 1 illustrates a preferred embodiment of the present invention. The invention has a base 2 upon which all the remaining components of the apparatus are attached. In a spring loaded trap such as this, the spring 4 creates the tension in the trap. The spring loaded arm 12 is an extension of the spring 4. The spring loaded arm 12 is held in place by a release 6. When a particular pest, in this case a mouse or rat, steps on the base 2 the trap does not immediately activate. The mouse or rat must first hit the trip switch 10. In order to promote the mouse or rat to trigger the trip switch 10 bait is usually applied to the trip switch 10. The bait can be any number of food items including fruits, nuts, peanut butter, or the like.

Once the trip switch 10 has been triggered, the release mechanism 14 enables the release 6 to allow the energy present in the spring 4 to be released. When the spring 4 returns to its natural state, the spring loaded arm 12 quickly follows. The snapping of the spring loaded arm 12 is with such force that it is sufficient to kill the invading pest. Additionally, the snapping of the spring loaded arm 12 creates a gravitational force (g-force) disturbance that disperses through the base 2 of the trap, which is registered by an accelerometer 26 coupled to a wireless transmitter 8.

The wireless transmitter 8 is coupled to the base 2. The wireless transmitter 8 may be coupled to the base 2 by adhesive means such as tapes, glues, or magnets. Additionally, it may be coupled by mechanical means such as screws. The wireless transmitter 8 detects the changes in the g-force emanating through the base 2. Once a predetermined g-force threshold is attained, the wireless transmitter 8 sends a signal to the wireless receiver. Additionally, these predetermined thresholds may correspond to events other than the trap closing. The wireless transmitter 8 may be able to distinguish different g-force levels that correspond to other activities such as removal of a dead animal, the trap being moved, or an animal eating the bait on the trip switch 10 or base 2. These thresholds and the corresponding alert may be user configurable based on what the user chooses to receive. It can be appreciated by those skilled in the art that spring traps are not the only trapping apparatus that can be used in such a manner. The types of traps that may be employed include live traps, poison traps, and glue traps amongst others.

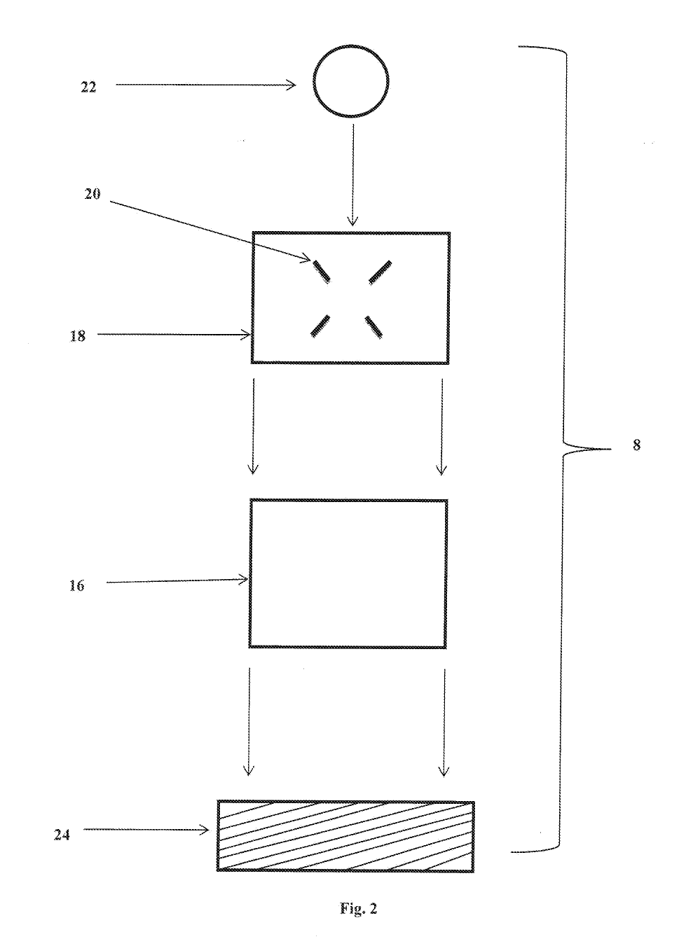

The wireless transmitter 8 is the combination of a number of individual components as demonstrated by FIG. 2. Preferably, the wireless transmitter 8 is powered by a lithium coin cell battery 22. In alternate embodiments, the battery may be a similar battery such as another coin cell or button cell battery. The components of the battery may vary and can include those typically included in such batteries such as lithium, zinc, silver oxide, carbon monofluoride, and cupric oxide. This, in turn, provides the power source for the trap and its wireless capabilities. The lithium coin cell battery 22 fits into the battery mounts 20 on the surface of the printed circuit board 18. The printed circuit board 18 has a digital accelerometer 26 embedded therein which measures the gravitational force changes in the trap. These components are preferably encased in an epoxy 16 providing a protective shell. Alternatively, the components may be encased in a urethane or other similar protective coating. The epoxy 16 protects the interior components from liquid damage and from damage stemming from the pests. This epoxy 16 also makes it possible for the entire apparatus to be hosed off or placed in a dishwasher or cleaned by other means without a worry for damage to the apparatus. Additionally, it protects the components from dust, dirt, and the like and enables the trap to be placed in a variety of locations without fear of damaging or destroying the device. On at least one side of the epoxy 16 there is an adhesive 24. This adhesive 24 may be any number of adhesion means including magnets, glues, or tapes. The adhesive 24 may be replaced as necessary.

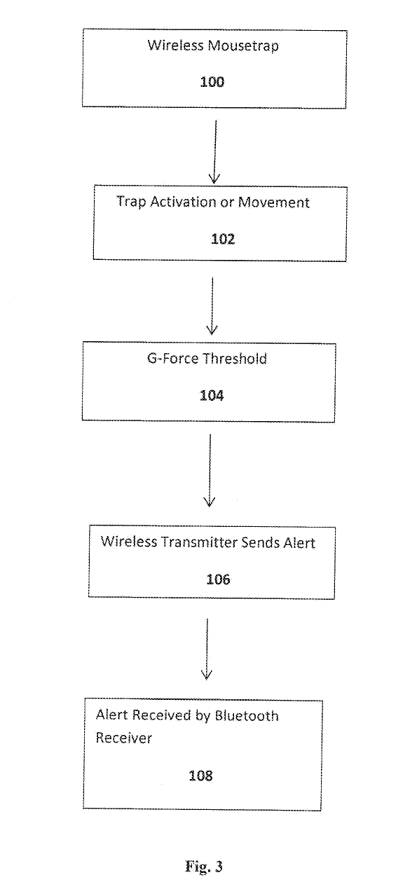

The system as a whole is described by FIG. 3. The system is defined the by the trap 100 and Bluetooth® receiver 108. The trap 100 may be any rodent trap or the like with or without movable parts. The change in the status of these movable parts creates a gravitational force which can be registered and measured by the apparatus. Alternatively, the movement of the trap itself (i.e. mouse in a glue trap) can be enough to create the force necessary to send an alert. The Bluetooth® receiver 108 is any device with Bluetooth® capabilities. These may include but are not limited to laptops, PCs, smart phones, PDAs, or tablet devices. This creates a distinct advantage over the prior art, in that the system does not require a dedicated transmitter and receiver. This is achieved because the trap 100 can be paired with any Bluetooth receiver 108, whereas other systems require specific frequencies or network connections to enable communication. To create an initial pairing between the devices 108 and 100, the user will preferably employ near field communications (NFC). This is achieved by bringing the two devices within a predescribed proximity to one another. Once within the field of communication, the wireless transmitter 8 and receiver 108 pair and the system communication is complete. Alternatively, the user may have to nudge the accelerometer 26 to create a pairing. Nudging the accelerometer 26 wakes up the device and allows pairing. Yet, in other embodiments, the pairing between the wireless transmitter 8 and receiver 108 is achieved through a simple push button pairing.

Once the pest or rodent activates the trap 102 the trap encloses or kills the pest or rodent. Again, with the use of alternate trapping methods, the animal may remain alive after trapping. Normally, the animal would stay in this state until the trap is manually checked. However, once the gravitational force threshold 104 is reached as a result of the trap closing an alert is sent 106. The gravitational force threshold 104 may be programmable or set to a predetermined level depending on the trap to which it is coupled. The alert is sent 106 at least one time to the Bluetooth® receiver 108. This alert 106 can be audio in nature such as a chime, tone, song, or vibration. Additionally, the alert 106 can be visual in nature such as a light, flashing of lights, image, text, or email message. Once the Bluetooth® receiver 108 has received the alert 106 the user knows that the trap has sprung and can check the trap.

What is claimed is:

1. A wireless trap comprising:
a mousetrap the mousetrap having movable parts;
a wireless transmitter coupled to the mousetrap, the wireless transmitter being capable of communicating with non-dedicated receivers; and
a digital accelerometer coupled to the wireless transmitter.

2. The wireless trap of claim 1 further comprising a power source such as a lithium coin cell battery.

3. The wireless trap of claim 1 wherein the wireless transmitter enables communication over Bluetooth® low energy channels.

4. The wireless trap of claim 1 wherein the wireless transmitter is encased in an element protective coating such as an epoxy or urethane.

5. The wireless trap of claim 1 wherein the wireless trap is a spring loaded trap.

6. The wireless trap of claim 1 wherein the wireless trap is a live trap.

7. The wireless trap of claim 1 wherein the digital accelerometer measures a gravitational force threshold.

8. The wireless trap of claim 7 wherein the accelerometer has multiple sensitivity settings.

9. The wireless trap of claim 1 wherein the mousetrap has no movable parts and the trap is a glue based trap.

10. A system of monitoring a wireless trap comprising:
a wireless mousetrap; and
a receiver, the receiver having Bluetooth® low energy capabilities.

11. The system of claim 10 wherein an alert is sent to the receiver.

12. The system of claim 11 wherein the alert is audio, vibrational, or visual in nature.

13. The system of claim 12 wherein the alert is sent at least one time.

14. The system of claim 10 wherein the initial pairing between the wireless trap and the receiver is achieved by employing near field communications (NFC), tapping the accelerometer, or by push button coupling.
